(19) United States
(12) Patent Application Publication
(10) Pub. No.: US 2013/0105063 A1
(43) Pub. Date: May 2, 2013

(54) SYSTEM AND METHOD FOR FABRICATING A LAMINATE STRUCTURE

(71) Applicants: Walter J. Dauksher, Fort Collins, CO (US); Adam Gallegos, Fort Collins, CO (US)

(72) Inventors: Walter J. Dauksher, Fort Collins, CO (US); Adam Gallegos, Fort Collins, CO (US)

(73) Assignee: Avago Technologies Enterprise IP (Singapore) Pte. Ltd., Singapore (SG)

(21) Appl. No.: 13/287,323

(22) Filed: Nov. 2, 2011

(51) Int. Cl. B32B 41/00; B32B 37/02

(52) U.S. Cl. 156/64; 156/378

(57) ABSTRACT

A method for fabricating a laminate structure includes providing a laminate core, forming at least one laminate layer on each opposing side of the laminate core, the laminate core and the at least one laminate layer on each opposing side of the laminate core forming a laminate structure, determining an out-of-plane displacement for the laminate structure at a temperature of interest, the out-of-plane displacement corresponding to warpage, and if the warpage exceeds a predetermined value, modifying at least one of the laminate layers to reduce the warpage.

### BACKGROUND

A modern application specific integrated circuit (ASIC) can be fabricated and packaged in a number of different ways. One way of fabricating and packaging an ASIC is referred to as a “flip-chip” structure. In a flip-chip structure the ASIC package is attached to a printed circuit (PC) board using, for example, an array of solder balls. The flip-chip package typically includes a substrate to which the active circuitry, referred to as the “chip” is mounted, typically using an array of solder bumps. The substrate is typically fabricated using a multi-layer laminate structure, which includes a core material over which one or more layers are fabricated. The layers are typically fabricated on opposing sides of the core and generally include one or more power planes, ground planes, signal traces, vias, and other electrically conductive interconnect layers, non-conductive layers, conductive structures, and other layers and structures. An example of the material that forms the core includes reinforced glass fibers with resins, such as FR4, etc. An example of the material used to form the conductive layers or conductive elements and structures within layers is copper. The non-conductive layers or regions of layers typically comprise solder mask material, also referred to as solder resist material, and can comprise epoxy resin, photosensitive resin, or other non-conductive material. The substrate structure is typically fabricated using known PC board fabrication techniques, and is typically fabricated at elevated temperature and pressure.

When attaching the chip to the substrate using the above-mentioned solder bumps, it is important that the laminate structure forming the substrate remain as flat as possible to facilitate satisfactory electrical and mechanical connections. However, when the chip is attached to the substrate, the temperature of the assembly must be sufficiently elevated to permit the solder bumps to melt, typically referred to as the reflow temperature. The reflow temperature typically depends on the properties of the material from which the solder bumps are formed. If the substrate warps during assembly of the chip to the substrate a sound mechanical and electrical connection from the chip to the substrate is difficult to achieve.

Prior methods to minimize substrate warping include balancing the amount, as a percentage of copper on layers of the substrate on opposing sides of the core. Unfortunately, these prior methods fail to consider many properties of the materials and, for multi-material layers, the spatial distribution of the constituent materials that make up the layers.

Therefore, it would be desirable to have a way of predicting, compensating and minimizing warpage in a substrate material used to fabricate an ASIC.

### SUMMARY

In an embodiment, a method for fabricating a laminate structure, comprises providing a laminate core, forming at least one laminate layer on each opposing side of the laminate core, the laminate core and the at least one laminate layer on each opposing side of the laminate core forming a laminate structure, determining an out-of-plane displacement for the laminate structure at a temperature of interest, the out-of-plane displacement corresponding to warpage, and if the warpage exceeds a predetermined value, modifying at least one of the laminate layers to reduce the warpage.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating a portion of an application specific integrated circuit (ASIC) assembly including a laminate structure.

FIG. 2 is a schematic diagram illustrating a portion of the assembly of FIG. 1.

FIG. 3 is a schematic diagram illustrating an example of a layer portion of the laminate of FIG. 2.

FIG. 4 is a schematic diagram illustrating a layer portion of the laminate of FIG. 2.

FIGS. 5A and 5B are plan views illustrating surfaces of an example substrate.

FIG. 5C is a cross-sectional view of the example substrate of FIGS. 5A and 5B.

FIGS. 6A and 6B are schematic diagrams illustrating the unit cells of FIGS. 5A and 5B.

FIG. 7 is a graphical view showing the effective modulus (GPa) for the “plus” unit cell and “square” unit cell of FIGS. 6A and 6B.

FIG. 8 is a graphical view showing the effective coefficient of thermal expansion (ppm/° C.) for the “plus” unit cell and “square” unit cell of FIGS. 6A and 6B.

FIG. 9 is a schematic diagram illustrating an example of the warpage of a sample laminate structure.

FIG. 10 is a graphical diagram illustrating the amount of warpage of the laminate structure shown in FIG. 9 after being processed by the method described in FIG. 11.

FIG. 11 is a flowchart describing the operation of an embodiment of the system and method for fabricating a laminate structure.

FIG. 12 is a block diagram illustrating an example general purpose computer system for implementing the system and method for fabricating a laminate structure.

### DETAILED DESCRIPTION

A system and method for fabricating a laminate structure can be used in any application specific integrated circuit (ASIC) in which it is desirable to have a stable mounting package. Further, the system and method for fabricating a laminate structure can be used to fabricate a laminate structure for any application in which warpage predictability and stability is desirable. The system and method for fabricating a laminate structure can be implemented for any laminate structure.

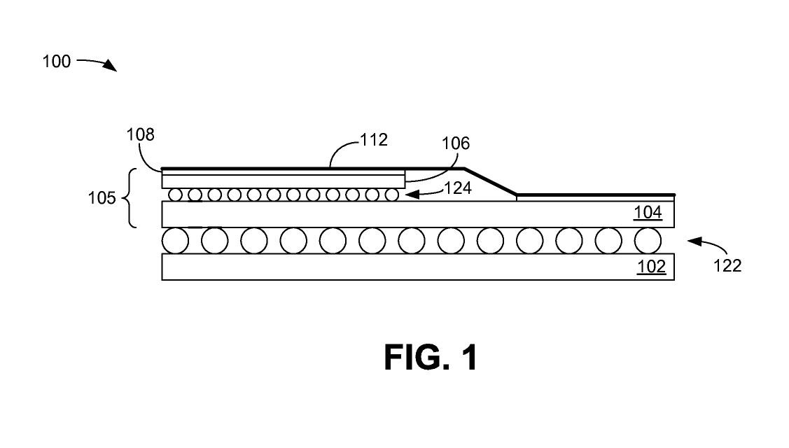

FIG. 1 is a schematic diagram illustrating a portion of an application specific integrated circuit (ASIC) assembly 100 including a laminate structure fabricated in accordance with embodiments of the invention. Assuming a single assembly temperature, a substrate composed of a laminate structure will tend to warp at all temperatures other than the assembly temperature. This warping will occur in laminates when there is an asymmetry in layer-to-layer properties, which is common in electronic package substrates, such that a thermal moment is created by changes in temperature. The system and method for fabricating a laminate structure minimizes the warpage at one or more temperatures of interest. The assembly 100 comprises a printed circuit (PC) board 102 over which a circuit package 105 is located and attached to the PC board 102 using solder balls 122. An example of a circuit package 105 can be a DRAM package or another circuit package. Further, the circuit package 105 can be a flip-chip package, or another circuit package as known to those skilled in the art. The PC board 102 can be any single-layer or multi-layer structure used to mount a circuit package, such as the circuit package 105, as known in the art. The solder balls 122 are an example of an attachment structure that can be used to electrically and mechanically attach the circuit package 105 to the PC board 102, and are known to those skilled in the art.

The circuit package 105 comprises a circuit element, also referred to as a “chip” 106 located and attached to a substrate 104 using solder bumps 124. The chip 106 generally comprises the active circuit elements of the ASIC circuitry. The solder bumps 124 are an example of an attachment structure that can be used to electrically and mechanically attach the chip 106 to the substrate 104, and are known to those skilled in the art. An optional lid 112 can be attached to the circuit package 105 using an adhesive 108 as known to those skilled in the art.

The substrate 104 generally comprises a core and one or more layers formed on one or both sides of the core, thereby forming a laminate structure. The core and the layers formed thereon will be shown in greater detail below. The substrate 104 generally comprises a power distribution network and signal distribution traces that transfer power and signal connections between the PC board 102 and the chip 106. Generally, the form factor and the array of solder bumps 124 of the chip 106 dictate that connection to the PC board 102 and the array of solder balls 122 occur through an adaptive connection. The substrate 104 serves this adaptive connection function coupling the chip 106 to the PC board 102, and distributing the connections between the chip 106 and the PC board 102. The substrate 104 generally comprises one or more power layers, ground plane layers, and wiring interconnects. The substrate 104 may also include one or more passages, referred to as “vias” that provide electrical connectivity between and among the various layers of the substrate 104. In an embodiment, the substrate 104 is fabricated to minimize its tendency to warp when the substrate 104 is heated to allow the solder bumps 124 to reflow.

In the embodiment shown, the chip 106 is located over the substrate 104 and a periphery of the chip 106 is generally contained within the periphery of the substrate 104. Further, the substrate 104 is located over the PC board 102, and a periphery of the substrate 104 is generally contained within a periphery of the PC board 102.

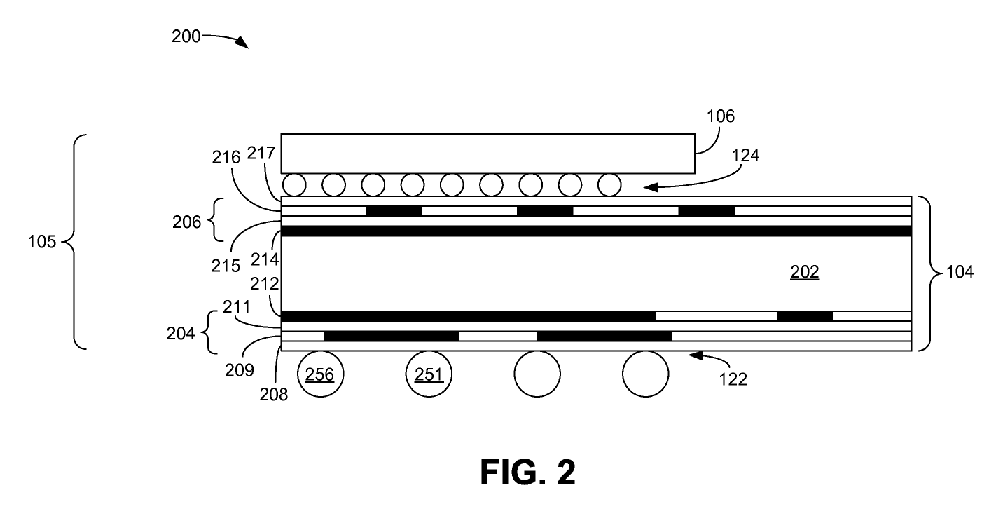

FIG. 2 is a schematic diagram illustrating a portion 200 of the assembly of FIG. 1. The portion 200 generally comprises portions of the circuit package 105, chip 106 and substrate 104.

The substrate 104 generally comprises a laminate structure comprising a laminate core 202 and layers 204 and 206. For example purposes only, the laminate core 202 can be fabricated from a glass fiber material, or another suitable material known to those skilled in the art. For example purposes only, the layers 204 comprise individual layers 208, 209, 211 and 212; and the layers 206 comprise individual layers 214, 215, 216 and 217. The layers 204 and 206 are illustrated as each comprising four layers, but those skilled in the art will recognize that layers 204 and 206 may comprise more or fewer layers, and may each comprise a different number of layers. Moreover, the layers 204 and 206 generally include a combination of conductive metal material, such as copper, and non-conductive dielectric material, such as epoxy resins, photosensitive resins, etc. An individual layer within the layers 204 and 206 may comprise only conductive material, non-conductive material, or a combination of conductive and non-conductive material. For example purposes only, conductive material in the layers 204 and 206 in FIG. 2 is depicted using the color black and non-conductive material in the layers 204 and 206 in FIG. 2 is depicted using the color white. The layers 204 and 206 generally include a combination of dielectric material and material used to construct electrical interconnects including, but not limited to, copper, or other conductive material to form circuit traces and circuit pads, and other non-conductive material to form non-conductive elements and structures.

The materials within the layers 204 and 206 are distributed so as to provide the desired electrical interconnect, electrical power delivery, electrical ground, etc. Therefore, it is unlikely that the area and spatial distribution of material that forms the individual layers 208, 209, 211 and 212 on one side of the core 202 will be equivalent to the area and spatial distribution of material that forms the layers 214, 215, 216 and 217 on the opposite side of the core 202. Accordingly, there are differences in the area distribution, spatial distribution, volume distribution, weight, etc., of the materials in the layers 204 and 206. This mismatch in the material distribution in the layers 204 and 206 gives rise to the likelihood of substrate warpage when the substrate is heated or cooled to any temperature other than its assembly temperature and in particular the temperature at which the solder bumps 124 reflow to attach the chip 106 to the substrate 104.

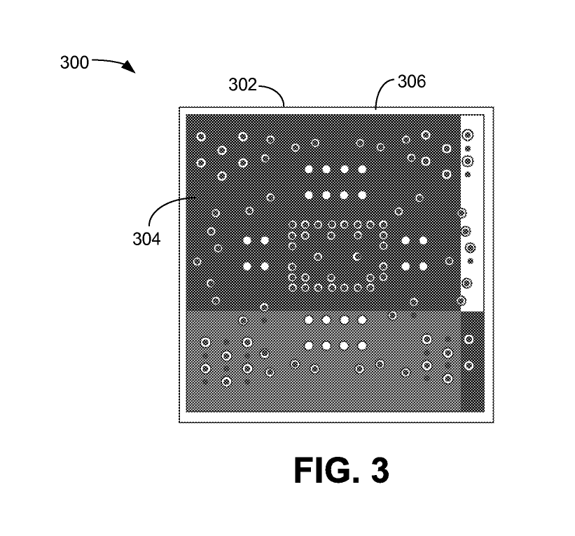

FIG. 3 is a schematic diagram 300 illustrating an example of a layer portion 302. The layer portion 302 is an example of any of the layers 204 and 206 shown in FIG. 2. In the embodiment shown in FIG. 3, the layer portion 302 includes portions of conductive material 304 and non-conductive material 306, the conductive material 304 and the non-conductive material 306 forming a composite layer structure. However, the layer portion 302 may include only conductive or non-conductive material. As illustrated in FIG. 3, the conductive material 304, which for example can be copper or an alloy comprising copper or other materials, is distributed within the layer portion 302 as a plane of conductive material. In this example, the conductive material 304 may comprise a power or ground plane.

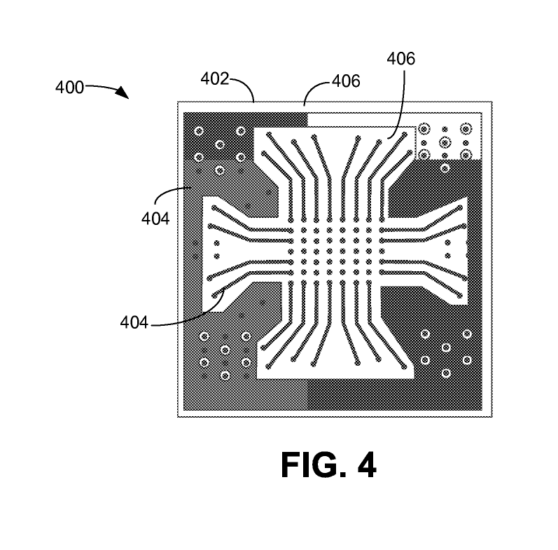

FIG. 4 is a schematic diagram 400 illustrating a layer portion of the laminate of FIG. 2. The layer portion 402, in similar fashion to the layer portion 302 of FIG. 3, can be one or a portion of any of the layers 204 and 206 in FIG. 2. In FIG. 4, the conductive material is illustrated using reference numeral 404 and the non-conductive material is illustrated using reference numeral 406. The conductive material 404 and the non-conductive material 406 form a composite layer structure. As illustrated in FIG. 4, the conductive material 404 is illustrated as a series of lines, or circuit traces, which are arranged substantially in a radial pattern within the non-conductive material 406. Even if the percent of area covered by the conductive material 304, 404, in FIGS. 3 and 4, respectively, is the same, the difference in the spatial allocation of the conductive material 304 and the conductive material 404 can give rise to different mechanical characteristics, resulting in differing mechanical behavior as a result of temperature variances. The difference in mechanical properties resulting from the distribution of conductive material and non-conductive material between FIG. 3 and FIG. 4 illustrates that, when subject to a temperature other than the temperature at which the substrate was formed, the composite layer 302 in FIG. 3 will expand and contract at a rate different from the expansion and contraction of the composite layer 402 in FIG. 4. For a substrate having layers 302 and 402 on opposite sides of a core, the warpage is caused by a difference in the in-plane expansions of the respective composite layers 302 and 402. Regarding the warping factor as it relates to the out-of-plane displacement, as known in the art of plate theory and plate structures, a plate structure is defined as one that has a lateral dimension that is approximately 10-20× or more its thickness, hence, a “plane.” In such a plate structure, the term “in-plane” describes a quantity in the direction of the lateral dimensions (e.g., an expansion which changes the lateral dimension) and the term “out-of-plane” describes a quantity which is normal to the lateral dimension. In this example, an “out-of-plane” displacement is normal to the defined “plane” and is used to characterize warping. For example purposes only, because of this difference in the distribution of conductive material, which in this example is a metal, and a non-conductive material, which in this example can be a dielectric, between the layer portions 302 and 402, a laminate structure fabricated with the layer portion 302 on one side of the core 202, and the layer portion 402 on the opposite side of the core 202, is likely to warp when subjected to any temperature other than the temperature at which the laminate structure is initially formed, such as when the chip 106 is mounted to the substrate 104. The warpage may exceed a predetermined amount and give rise to poor mechanical and electrical connections between the chip 106 and the substrate 104.

### Example

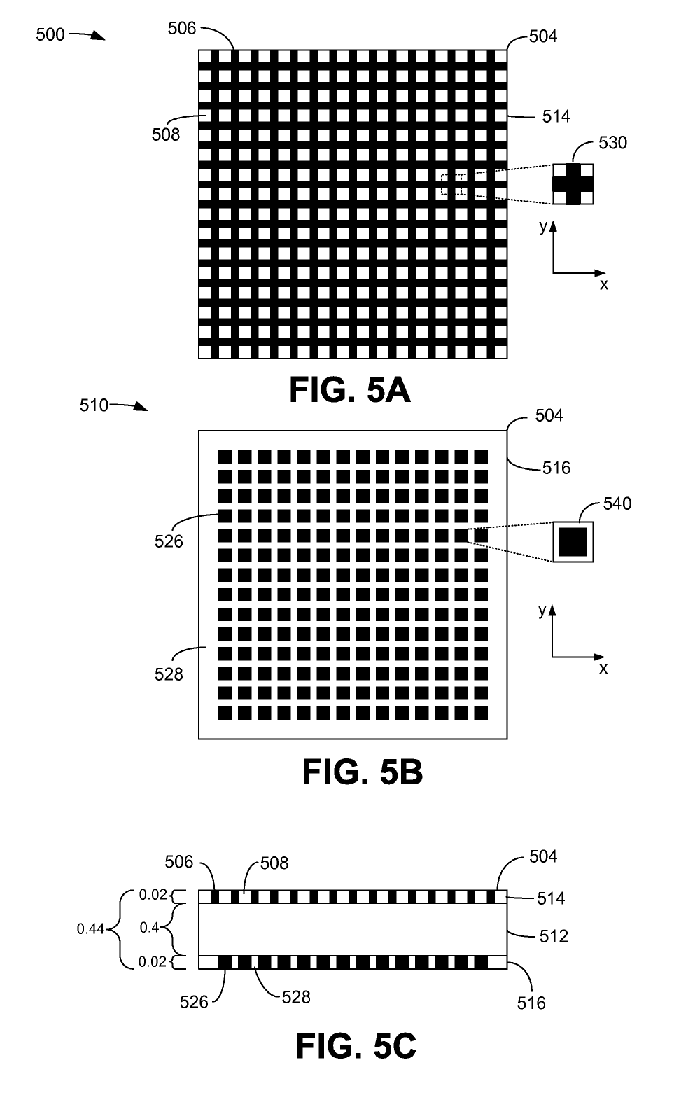

FIGS. 5A and 5B are plan views 500 and 510, respectively, illustrating surfaces of an example substrate 504. FIG. 5C is a cross-sectional view of the example substrate of FIGS. 5A and 5B.

In the example, the substrate 504 comprises a three layer laminated structure having an example edge length of 50 millimeters (mm) and an example thickness of 0.44 mm. All dimensions given are approximate. The core layer 512 is 0.4 mm thick, exhibits an isotropic characteristic and has the following material properties: Young's modulus, E, is 20 GPa, coefficient of thermal expansion, α, is 10 ppm/° C., and Poisson's ratio, ν, is 0.25. On either side of the core 512 are single composite layers 514 and 516, each formed from a metal, such as copper, and a dielectric, such as an epoxy. The layer 514 includes copper 506 and epoxy 508. The layer 516 includes copper 526 and epoxy 528. The layers 514 and 516 are referred to as “built-up layers,” the fabrication of which is known to those skilled in the art. The isotropic mechanical properties of the copper are E=125 GPa, α=16 ppm/° C., ν=0.25 and the isotropic mechanical properties of the epoxy are E=6 GPa, α=40 ppm/° C., ν=0.25. For the purposes of the example, all material properties are constant for the temperature ranges examined.

Each of the built-up layers 514 and 516 is 0.02 mm thick. In this example, the thickness of copper and epoxy on each layer 514 and 516 is equal to that of the layer, 0.02 mm. To simplify this example, the spatial distribution of the copper 506, 526 and epoxy 508, 528 in the respective built-up layers 514 and 516 is made in regular, repeating patterns where the edge length of each repeating pattern is small with respect to the edge length of the substrate 504 so that the composite mechanical properties of the respective layers may be easily evaluated. For layer 514 in the example, the regular repeating geometric pattern is the grid shown in FIG. 5A. The layer 514 may be formed by repeating the geometric pattern shown in the simplified unit cell 530. The thermo-mechanical properties of the built-up layer 514 may be determined by evaluating the thermo-mechanical properties of the unit cell 530. For simplicity, the structure of the unit cell 530 will be referred to as the “plus” design and planar directions “x” and “y” are specified for this structure, the substrate 504, layer 514 and subsequent results for this example.

For layer 516 in the example, the regular repeating geometric pattern is the grid shown in FIG. 5B. The layer 516 may be formed by repeating the geometric pattern shown in the simplified unit cell 540. The thermo-mechanical properties of the built-up layer 516 may be determined by evaluating the thermo-mechanical properties of the unit cell 540. For simplicity, the structure of the unit cell 540 will be referred to as the “square” design and planar directions “x” and “y” are specified for this structure, the substrate 504, layer 516 and subsequent results for this example.

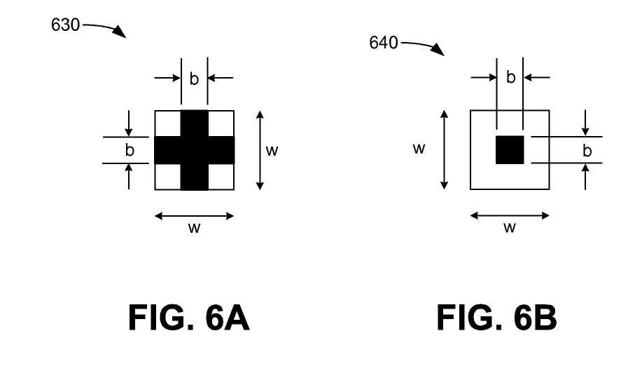

FIGS. 6A and 6B are schematic diagrams illustrating examples of the unit cells of FIGS. 5A and 5B, respectively. As an example, FIG. 6A shows a unit cell 630, which is similar to the unit cell 530 of the layer 514 and FIG. 6B shows a unit cell 640, which is similar to the unit cell 540 of the layer 516. The “plus” unit cell 630 is the characteristic unit cell defining the layer 514 and corresponds to the “plus” unit cell 530. The “square” unit cell 640 is the characteristic unit cell defining the layer 516 and corresponds to the “square” unit cell 540. However, while the unit cells 530 and 540 of FIGS. 5A and 5B are illustrated as each having a 50% metal (copper) content and a 50% dielectric (epoxy) content, the unit cells 630 and 640 are shown as having dimensions that can be independently adjusted to determine the metal and dielectric content.

Each unit cell 630 and 640 has a characteristic edge length “w” and a dimension “b” which identifies a defining copper dimension in each design. For both the “plus” unit cell 630 and the “square” unit cell 640, as the dimension “b” approaches zero, the unit cell will have the mechanical material properties, E, α and ν, of the epoxy and when b=w, the mechanical properties will be those of copper. For 0<b<w, the existence of both materials (copper and epoxy in this example) and the spatial placement of those materials, will affect the mechanical material properties as measured on the boundary of the unit cell. While a number of methods are available for determining these composite properties, a strength of materials method is used in this example. The resulting approximation of the composite properties in both x and y directions is presented in Table 1. For both constructions, σ is assumed to be 0.25. In Table 1, E_{eff} and α_{eff} refer to the effective or composite moduli and coefficient of thermal expansion as measured on the perimeter of the unit cells. The subscript d indicates dielectric and the subscript m denotes metal.

TABLE 1

| | Square | Plus |
|---|---|---|
| E_{eff} | $\frac{{w}^{2} {E}_{d}^{2} + {wbE}_{d} ( {E}_{m} - {E}_{d} )}{{w}^{2} {E}_{d} + ( wb - {b}^{2} ) ( {E}_{m} - {E}_{d} )}$ | $\frac{{w}^{2} {E}_{d} {E}_{m} + {wbE}_{m} ( {E}_{m} - {E}_{d} )}{{w}^{2} {E}_{m} + ( {b}^{2} - wb ) ( {E}_{m} - {E}_{d} )}$ |
| α_{eff} | ${α}_{d} + \frac{b}{w} ( {α}_{m} - {α}_{d} + \frac{( {α}_{d} - {α}_{m} ) ( w - b ) {E}_{b}}{{bE}_{m} + ( w - b ) {E}_{d}} )$ | ${α}_{m} + ( 1 - \frac{b}{w} ) ( \frac{( {α}_{d} - {α}_{m} ) ( w - b ) {E}_{b}}{{bE}_{m} + ( w - b ) {E}_{d}} )$ |

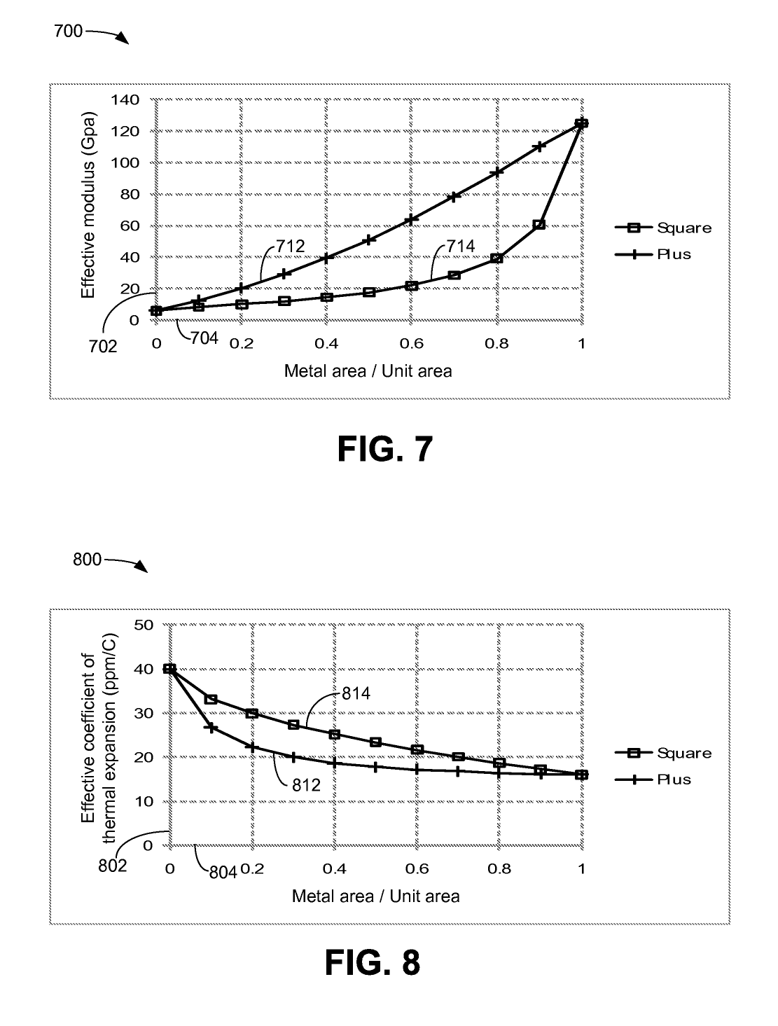

FIG. 7 is a graphical view 700 showing the effective modulus (GPa) for the “plus” unit cell 630 and “square” unit cell 640 of FIGS. 6A and 6B. The vertical axis 702 represents the effective modulus (GPa) and the horizontal axis 704 represents the area of metal (copper, in this example) per unit area. The curve 712 represents the “plus” unit cell 630 and the curve 714 represents the “square” unit cell 640.

FIG. 8 is a graphical view 800 showing the effective coefficient of thermal expansion (ppm/C) for the “plus” unit cell 630 and “square” unit cell 640 of FIGS. 6A and 6B. Values are presented as a function of the metal density in the unit cell. The vertical axis 802 represents the effective coefficient of thermal expansion (ppm/° C.) and the horizontal axis 804 represents the area of metal (copper, in this example) per unit area. The curve 812 represents the “plus” unit cell 630 and the curve 814 represents the “square” unit cell 640.

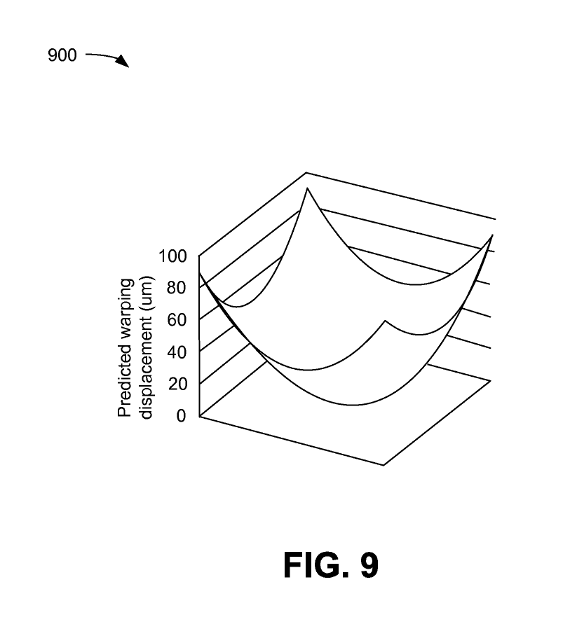

In the example, the upper built-up layer 514 is analyzed using the “plus” unit cell 630 and the bottom built-up layer 516 is analyzed using the “square” unit cell 640. The substrate 504 is assembled and cured flat at the “cure” temperature and is joined to a flip chip (not shown) at another temperature which differs from the cure temperature by 50° C. As an arbitrary starting point, the metal density is chosen to be 50% on each built-up layer 514, 516. However, other metal density amounts are possible and the metal density of each layer may be different. The out-of-plane displacement for the three-layer substrate 504 is calculated using laminated plate theory and the previously discussed material properties. For the 50° C. temperature change, the predicted out-of-plane displacement is shown below in FIG. 9 and exhibits a maximum value of approximately 0.085 mm. The warping arises from the differences in effective moduli and coefficients of thermal expansion between the “plus” unit cell 630 and “square” unit cell 640 used to analyze the built-up layers 514 and 516, respectively. The total amount of copper by area on each built-up layer 514 and 516 is the same, but the differing spatial allocations of copper and epoxy lead to substantial differences in effective or composite mechanical properties for the respective layers 514 and 516. For the example of 50% metal density, the effective modulus and coefficient of thermal expansion of the layer 514 analyzed using the “plus” unit cell, 630, are approximately 250% and 30%, respectively, greater than those of the layer 516 analyzed using the “square” unit cell, 640, giving rise to the warping illustrated in FIG. 9.

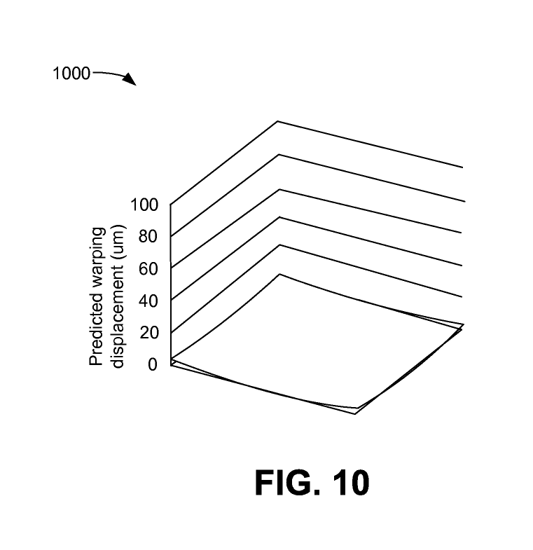

In this example, in order to minimize the temperature-induced warpage, the metal density is adjusted in the layer 516 that was analyzed using the “square” unit cell 640. For the layer 516, the choice of b/w=0.9295 (and corresponding copper areal density of 86.4%) caused the maximum warpage due to the 50° C. temperature excursion to be less than 0.001 mm, which is shown highly exaggerated in FIG. 10.

A three layer laminate structure is shown for example only. The system and method for fabricating a laminate structure can be applied to laminate structures having more or fewer layers. Further, while different unit cell structures are shown on opposing sides of the core layer 512, the same unit cell can appear on opposing sides of the core layer 512. In practice, many more layers are typically located on opposing sides of the core layer 512. Each of these layers can be analyzed as described above to determine the structure's propensity for warping.

The foregoing example is simplified for ease of explanation. In practice, the balancing of a typical electronic package substrate may be much more involved, particularly due to restrictions on metal trace and plane routing patterns, vias, temperature dependent material properties and a multitude of layers, among others.

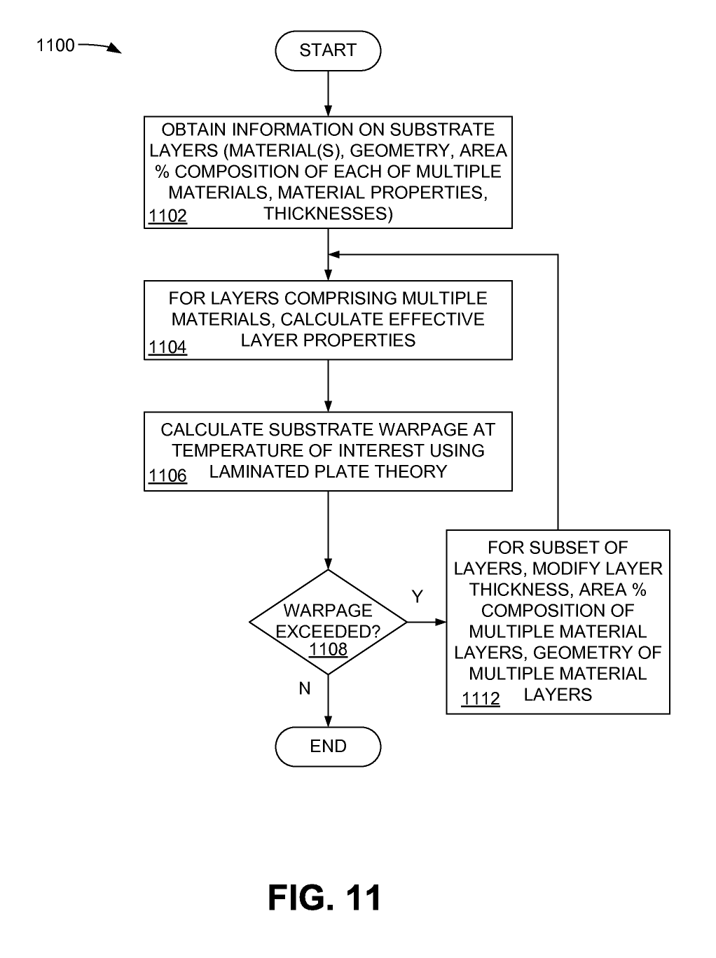

FIG. 11 is a flowchart describing the operation of an embodiment of the system and method for fabricating a laminate structure. In block 1102, information is obtained on the substrate layers. This information includes, but is not limited to, the materials used to form the layers, the mechanical properties of the materials used to form the layers, the geometry of the conductive and non-conductive material, the area percent composition of each of the layers and materials, the material thickness, and all other material properties.

In block 1104 it is determined, for each layer, the effective layer properties, especially for layers comprising multiple materials. In the case of a homogeneous layer, e.g., one comprising entirely isotropic dielectric material or metal material, the effective layer properties are the mechanical properties of the dielectric material or the metal material. In the case of a layer composed of multiple materials, the effective properties will reflect those of the constituent materials, the amount of each material present and the geometry of the structures in the layer. Considering the example layers shown in the example above using FIGS. 5A, 5B and 5C and assuming that the layers are the same size and that the amount of conducting (black) material is the same on layer 514 and layer 516, the in-plane stiffness and expansion with temperature will be different for the two layers, due to the difference in the spatial allocation of the conducting material. The effective properties may be calculated in a number of ways, including, for example, closed form analytic and numerical methods.

In block 1106, the amount of warpage at the temperature of interest is calculated for the entire substrate using the effective properties of each constituent layer. As discussed herein, the substrate warping is evaluated using laminated plate theory, which is well known in the composite materials field. Other methods, for example, closed-form analytic, numeric, etc., may be substituted as an evaluation method. Briefly, substrate warping and twisting will be caused by the thermal forces and moments created within the substrate by temperature change and the resulting curvatures these forces and moments cause. Warpage is decreased by decreasing the thermal forces and moments and by changes to the substrate's stiffness. Such beneficial changes may be affected by changes to the thickness of any of the layers and changes to the layout of composite layers.

In block 1108, it is determined whether the amount of tolerable warpage is exceeded. For example, in the case of a flip-chip package, the tolerable warpage may be specified in the chip attach area and may be specified as a percentage of the solder bump height. If, in block 1108 it is determined that the amount of tolerable warpage is not exceeded, then the process ends. If however, in block 1108 it is determined that the amount of tolerable warpage is exceeded, then, in block 1112, for one or more layers, the layer properties, including but not limited to thickness, area percent composition of multiple material layers, the geometry of the layers, and the material of the layers, etc., is modified to reduce the warpage. The warpage calculation obtained in block 1106 is used to determine which layers and which layer properties are modified. After modification in block 1112, the process returns to block 1104.

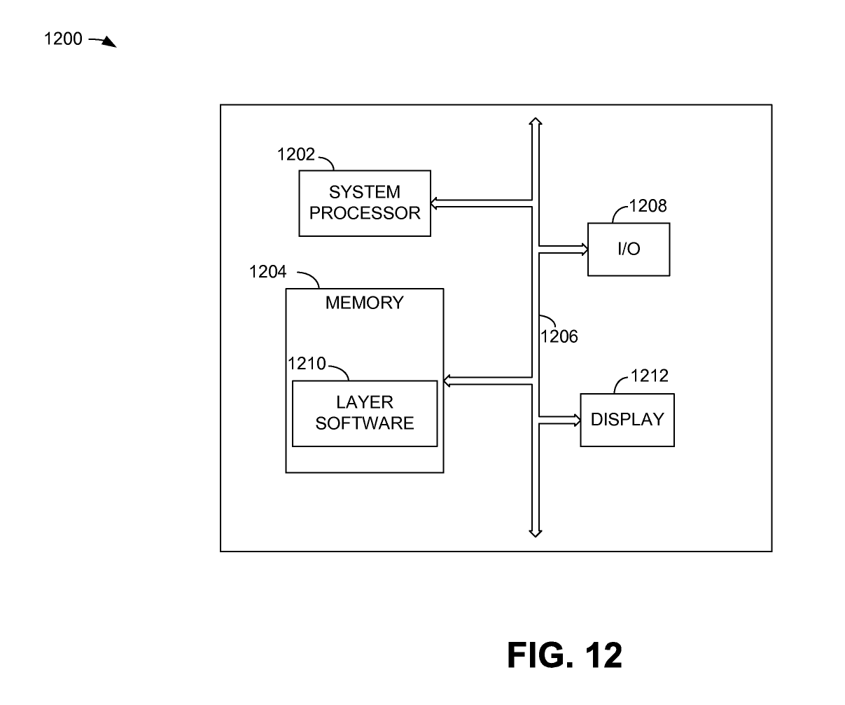

FIG. 12 is a block diagram illustrating an example general purpose computer system for implementing the system and method for fabricating a laminate structure. The computer system 1200 can be any general-purpose or computer system for executing instructions. In view of the disclosure herein, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the figures, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Further, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

The terms disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

The system 1200 comprises a system processor 1202, which can be a general purpose or special purpose microprocessor, memory 1204, layer property calculation software 1210, an input/output (I/O) element 1208 and a display 1212, operatively connected together over a system bus 1206. The system bus 1206 can include the physical and logical connections to couple the above-described elements together and enable their interoperability.

The I/O element 1208 can include, for example, a keyboard, a mouse, a pointing device, user interface control elements, and any other devices or systems that allow a user to provide input commands and receive outputs from the system 1200.

The memory 1204 can be any type of volatile or non-volatile memory, and in an embodiment, can include flash memory. The memory 1204 can be permanently installed in the system 1200, or can be a removable memory element, such as a removable memory card. The display 1212 can be a monitor or other device capable of providing a display to a user.

Although omitted from FIG. 12 for ease of illustration, the system 1200 also includes a power source, which can be an internal or external power source, and which can comprise, for example, an alternating current (AC) power adaptor or charger, a direct current (DC) adaptor or charger, a rechargeable power source, or another external or internal power source.

The system processor 1202 can be any processor that executes the layer property calculation software 1210 to fabricate a laminate structure as described herein. The memory 1204 can be volatile or non-volatile memory, and in an embodiment, can be non-volatile memory that stores the layer property calculation software 1210.

A substrate is laid out by a designer to comply with the “adaptive connection” discussed above. As known in the art, a “net list” of chip-to-substrate connections is made, power and ground connections are established and many of these connections should comply with signal integrity and power requirements. Additional requirements on the connections may be imposed by third parties to, for example, accommodate the plating process. The resulting net list produces an electrically correct and manufacturable substrate.

The layer properties are entered using, for example, the I/O element 1208, or are provided to the system 1200 in another manner, and layer property calculation software 1210 analyzes the layers and reports % Cu per layer.

Each layer is visually examined to determine the effective properties of that layer based on the % Cu and the spatial layout of the materials using the Strength of materials analysis described above.

The effective layer properties are then used as inputs for the layer property analysis using the laminated plate theory described above. This calculation determines the manner in which the substrate will react, based on the layers, the layer properties and the boundary conditions, which can be temperature as described above. This analysis is performed by the layer property calculation software 1210, which can be, for example, a program written in Java. If the resulting analysis using laminate plate theory reveals an unacceptable amount of warping at the temperature of interest, the layer properties are adjusted and recalculated to adjust some of the geometry and the analysis is repeated until an acceptable amount of warpage is shown. As a non-limiting example, changes in spatial allocation, area % of material, and thickness are effective ways to minimize the warpage.

While described as written in Java code, the layer property calculation software 1210 can be written in other languages. Further, the above described analysis can be performed on other computing devices, or can be done by hand.

As an alternative example, the analysis can be performed using a finite element code that imports the entire substrate and that performs the analysis without the need for the simplifications of the strength of materials or laminated plate theory methods described herein.

Currently, such finite element analysis is not practical for most substrates, but the analysis is possible. Therefore, the system and method for fabricating a laminate structure can be performed in a number of ways, exemplary embodiments being described herein.

This disclosure describes the invention in detail using illustrative embodiments. However, it is to be understood that the invention defined by the appended claims is not limited to the precise embodiments described.

What is claimed is:

1. A method for fabricating a laminate structure, comprising:
providing a laminate core;
forming at least one laminate layer on each opposing side of the laminate core, the laminate core and the at least one laminate layer on each opposing side of the laminate core forming a laminate structure;
determining an out-of-plane displacement for the laminate structure at a temperature of interest, the out-of-plane displacement corresponding to warpage; and
if the warpage exceeds a predetermined value, modifying at least one of the laminate layers to reduce the warpage.

2. The method of claim 1, wherein the modifying further comprises altering at least one layer property.

3. The method of claim 2, wherein the layer property is chosen from thickness, area percent composition of multiple material layers, the geometry of the layers, and the material of the layers.

4. The method of claim 3, wherein the at least one laminate layer on each opposing side of the laminate core comprises a composite layer having at least two different materials.

5. The method of claim 4, wherein the two different materials comprise a dielectric material and a metal material, the metal material being applied as a repeating unit cell pattern.

6. The method of claim 5, wherein a repeating unit cell on the at least one laminate layer on each opposing side of the laminate core is different than a repeating unit cell on another of the at least one laminate layer on each opposing side of the laminate core.

7. A system for fabricating a laminate structure, comprising:
a laminate core having at least one laminate layer on each opposing side of the laminate core, the laminate core and the at least one laminate layer on each opposing side of the laminate core forming a laminate structure;
a software module executing on a processor, the software module determining an out-of-plane displacement for the laminate structure at a temperature of interest, the out-of-plane displacement corresponding to warpage; and
if the warpage exceeds a predetermined value, the software module modifying at least one of the laminate layers to reduce the warpage.

8. The system of claim 7, wherein the modifying further comprises altering at least one layer property.

9. The system of claim 8, wherein the layer property is chosen from thickness, area percent composition of multiple material layers, the geometry of the layers, and the material of the layers.

10. The system of claim 9, wherein the at least one laminate layer on each opposing side of the laminate core comprises a composite layer having at least two different materials.

11. The system of claim 10, wherein the two different materials comprise a dielectric material and a metal material, the metal material being applied as a repeating unit cell pattern.

12. The system of claim 11, wherein a repeating unit cell on the at least one laminate layer on each opposing side of the laminate core is different than a repeating unit cell on another of the at least one laminate layer on each opposing side of the laminate core.

13. A method for fabricating a laminate structure, comprising:
providing a laminate core;
forming at least one laminate layer on each opposing side of the laminate core, the laminate core and the at least one laminate layer on each opposing side of the laminate core forming a laminate structure;
determining an out-of-plane displacement for the laminate structure at a temperature of interest, the out-of-plane displacement corresponding to warpage; and
if the warpage exceeds a predetermined value, modifying a layer property of at least one of the laminate layers to reduce the warpage, the layer property chosen from thickness, area percent composition of multiple material layers, the geometry of the layers, and the material of the layers.

14. The method of claim 13, wherein the at least one laminate layer on each opposing side of the laminate core comprises a composite layer having at least two different materials.

15. The method of claim 14, wherein the two different materials comprise a dielectric material and a metal material, the metal material being applied as a repeating unit cell pattern.

16. The method of claim 15, wherein a repeating unit cell on the at least one laminate layer on each opposing side of the laminate core is different than a repeating unit cell on another of the at least one laminate layer on each opposing side of the laminate core.
